(19) United States
(12) Patent Application Publication
(10) Pub. No.: US 2014/0278846 A1
(43) Pub. Date: Sep. 18, 2014

(54) SYSTEM, METHOD, AND COMPUTER-READABLE MEDIUM FOR CHARITABLE EVENT PROMOTION

(71) Applicant: CAUSETOWN SOLUTIONS, INC., Alexandria, VA (US)

(72) Inventors: Daniel Patrick McCabe, Alexandria, VA (US); Margaret Woo, Arlington, VA (US); Kevin Markham, Arlington, VA (US); Matthew Pearce, Atlanta, VA (US); Joshua Schulman, Millerton, NY (US)

(21) Appl. No.: 13/844,112

(22) Filed: Mar. 15, 2013

(51) Int. Cl. G06Q 30/02

(52) U.S. Cl. CPC G06Q 30/0279
USPC 705/14.4

(57) ABSTRACT

A method for creating and managing a charitable promotion. The method including receiving charitable promotion event information associated with a charitable promotion event, wherein the charitable promotion event information is received from one or more businesses; receiving names and addresses of the one or more businesses involved in the charitable promotion event; generating promotion materials based on the charitable promotion event information and the names and addresses; distributing the promotion materials; receiving details of purchases made in response to the charitable promotion; distributing an invoice to the one or more businesses showing amounts due related to the charitable promotion event; receiving selections of customer selected charities; receiving amounts due from the one or more businesses; and distributing donations due to the one or more customer selected charities.

### BACKGROUND

### Field of Invention

Embodiments of the invention relate generally to charitable events, and more particularly to a system, method, and computer-readable medium for charitable event promotion.

### SUMMARY

Aspects of the invention involve systems, methods, and computer readable medium. In one embodiment, a computer-implemented method may be provided for charitable event promotion. The method may comprise receiving, by a computer, charitable promotion event information associated with a charitable promotion event, wherein the charitable promotion event information is received from one or more businesses and includes at least one of: an event title, one or more event dates, an event description, or a percentage of sales to contribute to one or more customer selected charities; receiving, by the computer, names and addresses of the one or more businesses involved in the charitable promotion event; generating, by the computer, promotion materials based on the charitable promotion event information and the names and addresses of the one or more businesses; distributing, by the computer, the promotion materials based on the charitable promotion event information; receiving, by the computer, details of purchases made in response to the charitable promotion, wherein the details of purchases made are received from the one or more businesses and include contact information for customers and a purchase amount; distributing, by the computer, an invoice to the one or more businesses showing amounts due related to the charitable promotion event; receiving, by the computer, one or more selections of one or more customer selected charities, wherein the one or more selections are performed by one or more customers of the one or more businesses involved in the charitable promotion, the one or more selections are performed by the one or more customers of the one or more businesses at the point of sale or after the charitable promotion event; receiving, by the computer, amounts due from the one or more businesses, wherein the amounts due include donations related to purchases received by the one or more businesses involved in the charitable promotion event; and distributing, by the computer, donations due to the one or more customer selected charities.

In another embodiment a promotional system may be provided for creating and managing a charitable event promotion. The system may include an input device configured to receive charitable promotion event information associated with a charitable promotion event and includes at least one of: an event title, one or more event dates, an event description, a percentage of sales to contribute to one or more customer selected charities, names and addresses of one or more businesses involved in the charitable promotion event, or one or more selections of one or more customer selected charities, the one or more selections performed by the one or more customers of the one or more businesses at the point of sale or after the charitable promotion event; a storage device configured to store the charitable promotion event information; and at least one processor configured to: generate promotion materials based on the charitable promotion event information and the names and addresses of one or more businesses, and distribute the promotion materials based on the charitable promotion event information, calculate one or more contribution amounts for one or more customers based on the percentage of sales to contribute to one or more customer selected charities and one or more customer sales associated with the charitable promotion event, associate the one or more contribution amounts with the one or more selections of the one or more customer selected charities; and distribute an invoice to the one or more businesses showing amounts due related to the charitable promotion event.

In yet another embodiment, one or more tangible non-transitory computer-readable storage media may exist for storing computer-executable instructions executable by a computer system. The media may store one or more instructions for: receiving charitable promotion event information associated with a charitable promotion event, wherein the charitable promotion event is received from one or more businesses and includes at least one of: an event title, one or more event dates, an event description, or a percentage of sales to contribute to one or more customer selected charities; receiving names and addresses of one or more businesses involved in the charitable promotion event; generating promotion materials based on the charitable promotion event information and the names and addresses of one or more businesses; distributing the promotion materials based on the charitable promotion event information; receiving details of purchases made in response to the charitable promotion, wherein the details of purchases made are received from the one or more businesses and include contact information for customers and a purchase amount; distributing an invoice to the one or more businesses showing amounts due related to the charitable promotion event; receiving one or more selections of one or more customer selected charities, wherein the one or more selections are performed by one or more customers of the one or more businesses involved in the charitable promotion, the one or more selections are performed by the one or more customers of the one or more businesses at the point of sale or after the charitable promotion event; receiving amounts due from the one or more businesses, wherein the amounts due include donations related to purchases received by the one or more businesses involved in the charitable promotion event; and distributing donations to the one or more customer selected charities.

### BRIEF DESCRIPTION OF THE DRAWINGS

The foregoing and other features and advantages of the invention will be apparent from the following, more particular description of various exemplary embodiments, as illustrated in the accompanying drawings wherein like reference numbers generally indicate identical, functionally similar, and/or structurally similar elements. The first digits in the reference number generally indicates the drawing in which an element first appears.

FIG. 1 depicts a block diagram of an event promotion system in an example embodiment;

FIG. 2 depicts an illustrative workflow describing an example event promotion by a computer system;

FIG. 3 depicts an illustrative workflow describing an example promotion creation by a computer system;

FIG. 4 depicts an example block diagram of a customer experience during a promotional event held by a business;

FIG. 5 depicts an illustrative diagram of transmission paths used to send sales transaction data to the system;

FIG. 6 depicts an example screen shot of a web form for receiving transaction data from any Internet-enabled device;

FIG. 7 depicts an example screenshot of a business entering a custom message in an embodiment of the invention;

FIG. 8 depicts an example screenshot of an acknowledgment message received by a customer confirming the availability of funds for charitable donations in an embodiment of the invention;

FIG. 9 depicts an illustrative network diagram of example communication paths used to send information to businesses, Individuals, and/or organizations;

FIG. 10 depicts an example screenshot depicting choosing an organization to be the recipient of a donation;

FIG. 11 depicts an illustrative workflow describing fund collection and disbursement by a computer system;

FIG. 12 depicts an illustrative workflow describing an example progression of sales data collection and processing of sales information from a promotional event;

FIG. 13 depicts an illustrative example of a business report showing weekly, monthly, and recipient breakdowns;

FIG. 14 depicts an example screenshot of a customer transaction history report;

FIG. 15 depicts example organizations;

FIG. 16 contains an example screenshot of the administrative interface used for creating the framework of a campaign in an embodiment of the invention;

FIG. 17 contains an example screenshot of a launched campaign page in an embodiment of the invention;

FIG. 18 contains an example screenshot of an event template page in an embodiment of the invention;

FIG. 19 depicts an illustrative workflow of the source and delivery of computer generated promotional materials based on charitable promotion event information;

FIG. 20 depicts an example screenshot of computer generated promotional material individuals may use to indicate the charity they would like to receive the donation in an embodiment of the invention;

FIG. 21 depicts an example screenshot of computer generated flier for a charitable promotion event in an embodiment of the invention;

FIG. 22 depicts an example screenshot confirmation page in an embodiment of the invention;

FIG. 23 depicts an example screenshot of a webpage with RSS data provided by a pull of charitable promotional events in an embodiment of the invention.

FIG. 24 depicts an illustrative entity model of an event promotion system in an example embodiment;

FIG. 25 depicts an illustrative entity model of a donation disbursement system in an example embodiment;

FIG. 26 depicts an illustrative computer system.

### DESCRIPTION OF THE EMBODIMENTS

Exemplary embodiments are discussed in detail below. While specific exemplary embodiments are discussed, it should be understood that this is done for illustration purposes only. In describing and illustrating the exemplary embodiments, specific terminology is employed for the sake of clarity. However, the embodiments are not intended to be limited to the specific terminology so selected. A person skilled in the relevant art will recognize that other components and configurations may be used without parting from the spirit and scope of the embodiments. It is to be understood that each specific element includes all technical equivalents that operate in a similar manner to accomplish a similar purpose. The examples and embodiments described herein are non-limiting examples.

All publications cited herein are hereby incorporated by reference in their entirety.

As used herein, the term “a” refers to one or more. The terms “including,” “for example,” “such as,” “e.g.,” “may be” and the like, are meant to include, but not be limited to, the listed examples. The term “product” may refer to both products and services.

Large brand name corporations and charities may have used charitable partnerships and promotions to combine community relations, marketing, and customer engagement efforts. However, significant financial and human resources may be required to identify a charitable partner, devise and negotiate a meaningful campaign, execute program logistics, and communicate efforts to customers and the general public, for example. Many businesses and nonprofits in the world may not be able to afford the labor-intensive cost. However, the use of the Internet along with one or more specialized software application may be able to bring this concept within reach of every charity, business, and consumer.

Loyalty cards and giving customers an option to donate accrued loyalty points to a limited selection of charities may facilitate customer transactions. However, loyalty options do not fulfill functions involved with cause-related marketing, including, for example, matchmaking between nonprofits and businesses, assisting with campaign and/or program development, facilitating event scheduling and promotion, or tracking and/or reporting on the impact of charitable activities.

Requiring possession of a specific piece of physical hardware in order to utilize a charity program may also be problematic. Requiring hardware may prohibit nonprofits and businesses from partnering with one another if businesses and customers are required to possess a specific piece of physical hardware in order to utilize a charity program. For example, nonprofits cannot partner with businesses lacking the ability to accept such hardware nor can they engage customers that do not possess such hardware. However, in an embodiment of the invention described herein, any business, nonprofit or individual may instantly access a charity program, anyplace, anytime without any special equipment or hardware.

Forcing customers to choose from a limited number of pre-approved nonprofits may also be problematic. In an embodiment of the invention described herein every customer may be enabled to designate any public charity to receive a portion of their purchase at participating businesses, regardless of whether the nonprofit ever had any prior knowledge of the transaction. By allowing customers to choose their own favorite charities and relying on the invention to verify good standing with the IRS, the business may no longer need to waste time seeking out a specific nonprofit partner or limiting the impact of his or her promotion only to supporters who care about one particular cause.

FIG. 1 depicts a block diagram of an event promotion system in an example embodiment. In FIG. 1, Causetown 110 may enable the promotion of charitable events. Causetown 110 may be a computer or computers enabled to receive data and information from, for example, individuals 115, businesses 120, organizations 125 (e.g., registered and nonregistered nonprofit groups, parent teacher associations, schools, a fiscally-sponsored groups, etc.), and/or government entities. Causetown 110 may be connected to the Internet and/or to another network of interconnected computers (e.g., a virtual private network, a banking network, etc.). For example, Causetown 110 may enable connecting businesses 120 (e.g., local businesses) and nonprofit groups through charitable sales promotions.

Businesses 120 may include businesses that may connect to Causetown 110 via a computer network or other communication interface (e.g., smartphone, cell phone, mobile device, computer, tablet, web portal, point of sale device, etc.) through one or more devices such as a computer. Businesses 120 may, for example, create, publish, and manage the logistics of a cause-related marketing promotion in seconds. From a single webpage, for example, businesses 120 may create promotional event information 135. Promotional event information 135 may indicate a percentage of purchases 185 businesses 120 will donate to charity when a qualifying purchase is made, identify time limits or other restrictions, add an optional title and description, and/or publish the promotion, for example. Purchases 185 may include goods and/or services purchased from businesses 120. Causetown 110 may automatically distribute the promotional event information 135 as, for example, a fundraising opportunity for organizations 125 and/or the general public. In another embodiment, organizations 125 may also identify businesses 120 (e.g., nearby or local businesses) and initiate new partnerships and/or schedule fundraising promotions by using data, tools and/or communication templates provided by Causetown 110.

Individuals 115 may include people that may connect to Causetown 110 via a computer network or other communications interface (e.g., smartphone, cell phone, mobile device, computer, web portal, tablet, etc.). Individuals 115 may be able to select a charity (e.g., selected charities 170) through an interface to Causetown 110. For example, Causetown 110 may enable individuals 115 to designate a charity from, for example, a Public Charity 130 (e.g., 1,500,000+ IRS-approved charities, or public charities) to receive a portion of individuals 115 purchases 185 from businesses 120.

Causetown 110 may enable businesses 120 to instantly create, promote, and manage marketing promotions and/or give back days that give a percentage of sales to charity. Businesses 120 may do this on their own, in real-time, without requiring approval from Causetown 110, for example. Causetown 110 may receive from businesses 120 charitable promotion event information 135 derived from a proposed promotional event 140 an organization 125 created, for example. The charitable promotion event information 135 may include, for example, an event title, one or more event dates, an event description, and/or a percentage of sales to contribute to one or more customer selected charities. Causetown 110 may compile information from businesses 120 including the promotional event information 135 and business information and prepare and/or produce promotional event materials that may be distributed via promotional event distribution channels 180. Promotional event distribution channels 180 may include, for example, social media networks and feeds (e.g., TWITTER, FACEBOOK, LINKEDIN, etc.), email, and/or print.

Causetown 110 may include a billing records 145 that may be executed within Causetown 110 or separately and may be executed on one or more processors and/or devices. Information within billing records 145 may be stored in one or more databases or other file storing devices. Billing records 145 may store and distribute sales transactions 150, invoices 155, and/or payments 160. Sales transactions 150, invoices 155, and/or payments 160 may be received or transmitted to businesses 120. Sales transactions 150 may include sales of goods or services from businesses 120. Invoices 155 may include requests for donation funds 165 from businesses 120. Invoices 155 may be calculated based on the sales transactions 150 and the indicated percentage of sales to give to charity by businesses 120. Payments 160 may include payment from businesses 120 corresponding to invoices 155. Billing records 145 and/or Causetown 110 may record purchases from businesses 120, track aggregate amount due to charity from businesses 120, collect payments 160 from businesses 120, and/or distribute donation funds 165 to recipient organizations 175. Causetown 110 may distribute donation funds 165 to recipient organizations 175 based on customer selected charities 170. Causetown 110 may provide individuals 115, organizations 125, and businesses 120 real-time and historical reporting related to sales and/or donation transactions. Recipient organizations 175 may include any organization including non public charity organizations, nonpublic charities, schools, etc.

FIG. 2 depicts an illustrative workflow describing an example event promotion by a computer system. In 210, flow may begin and proceed to 220. In 220 charitable promotion event information 135 associated with a charitable promotion event 140 may be received by Causetown 110, for example. The charitable promotion event information 135 may be received from one or more businesses 120. Charitable promotion event information 135 may include, for example, an event title, one or more event dates, an event description, or a percentage of sales to contribute to one or more customer selected charities. From 220, flow may move to 230.

In 230, names and addresses of one or more businesses 120 involved in the charitable event may be received by Causetown 110, for example. From 230, flow may move to 240.

In 240, Causetown 110, for example, may generate promotional materials based on the charitable promotion event information 135 and the names and addresses of businesses 120. From 240, flow may move to 250.

In 250, Causetown 110, for example, may distribute the promotion materials based on charitable promotion event information 135. The promotion materials may be distributed, for example, through promotional event distribution channels 180. From 250, flow may move to 260.

In 260, Causetown 110 may receive details of purchases made in response to the charitable promotion. The details the details of purchases made may be received from businesses 120 and may include contact information of individuals 115 (e.g., customers of businesses 120) and purchase amount. From 260, flow may move to 265.

In 265, Causetown 110 may distribute an invoice or multiple invoices 155 to businesses 120 involved in the charitable promotion. Invoice or invoices 155 may include amounts due that are related to the charitable promotion event.

In 270, Causetown 110 may receive selections of customer selected charities 170. The selections may be performed by individuals 115 who are customers of businesses 120 involved in the charitable promotion. The selections of charities may be performed by customers of the businesses 120 at the point of sale or the selection of charities may be performed after the charitable promotion event. From 270, flow may move to 280.

In 280, Causetown 110 may receive amounts due (e.g., payments 160) from businesses 120. The amounts due may include donations 165 related to purchases received by the one or more businesses involved in the charitable promotion event. From 280, flow may move to 290.

In 290, Causetown 110 may distribute donations 165 due to the one or more customer selected charities. From 290, flow may move to 295 and end.

FIG. 3 depicts an illustrative workflow describing an example promotion creation by a computer system. Businesses 120 may create promotions in multiple different ways. For example, an organization of organizations 125 may create a proposal of proposed promotional events 140 for a promotion in 305 to benefit that organization. The proposal may be distributed 310 to one or more registered businesses 120. The one or more businesses 120 may ignore the proposal in 390, in which case the proposal simply expires in 320 after a period of time. The one or more businesses 120 may also respond with an alternative proposal in 390. The organization 125, upon notification in 315, may choose to decline the proposed changes in 395, in which case the one or more businesses 120 is notified in 397 and the proposal may continue to remain open for that or other businesses 120 to accept. The nonprofit 125 may also revise the proposal in 395 according to the changes requested in 390 by the one or more businesses 120 and in 396, the one or more businesses 120 may be notified that the revisions were made. The one or more businesses 120 may accept the revised promotion in 385. Once the revised promotion is accepted, the promotional event information 135 may be published and distributed in 350 by, for example, the promotional event distribution channels 180.

One or more businesses 120 may also receive targeted proposals from nonprofits and/or organizations 125 targeted specifically for an individual business. In 351, a targeted business may use a profile page to indicate a percentage of sales the targeted business is willing to donate to charity for organizations 125 and/or nonprofits. If organizations 125 and/or nonprofits schedules a promotion with the targeted businesses 120 in advance. In 351, the targeted business may list on the profile page one or more pre-approved days, times and percentages of sales to be donated. In 352, a nonprofit and/or organization 125 may schedule a promotion for one of those specific days listed on the targeted business profile page. In 353, the targeted business may accept the proposal submitted in 352. The promotion 135 may then be published and distributed in 350 by, for example, the promotional event distribution channels 180.

In 335, one or more businesses 120 may receive a campaign template webpage and continue to 340. In 340, one or more businesses 120 may join the campaign via a promotion template that includes dates, times, titles, descriptions and a recommended percentage of sales to donate through a charitable promotion corresponding to the promotional event information 135. Businesses 125 may use templates to quickly create compelling promotions corresponding to the promotional event information 135 without the need for a sophisticated marketing staff, for example. Campaigns may be templates that two or more businesses 120 may participate in and allow other businesses 120 to join by adding a promotion through the campaign template in 340. The promotional event information 135 resulting from 340 may be published and distributed in 350 by, for example, the promotional event distribution channels 180.

Finally, in 325, a business 120 may create an event, for example, by logging into a website and may continue to 330. In 330, one or more businesses 120 may submit details about the promotion and promotional event information 135, including date(s), time(s), description(s) and percentage of sales to be donated as part of the promotion. These promotions may allow individuals 115 who made purchases 185 to choose any charity and/or organization 125 in the country to receive a percentage of purchase 185. The promotional event information 135 resulting from 330 may be published and distributed in 350 by, for example, the promotional event distribution channels 180.

In 350, regardless of how promotional event information 135 is created, the associated promotion may receive a webpage, and in 365, may be published and distributed via Facebook and/or other online media as well as through Application Programming Interfaces (APIs) and/or Really Simple Syndication (RSS) data feeds in 371. Registered users may also receive notification of new promotions in 370 and nonprofits and/or organizations 125 as well as participating businesses 120 may use tools built into the promotional webpage to share event details with friends and supporters in 360.

In 375, individuals 115 may access a list of nearby promotions, or in 380, may comment on or share details of specific promotions through any of the above referenced communication media.

FIG. 4 depicts an example block diagram of a customer experience during a promotional event held by a business. The business may include one or more businesses 120. The customer may include one or more individuals 115 who purchased one or more goods or services from businesses 120. In 405, the customer may mention the charitable promotion to the cashier, for example, when paying a bill and continue to 410. Prior to the event, the business may have set up specific rules for the promotional event. The rules may dictate which permutations of the customer experience are possible. Specifically, the business may or may not choose to feature one or more charities in 410, the business may or may not allow customers to choose charities and/or organizations 125 other than the featured charities in 415, and/or the business may or may not allow the customer to select the charity and/or 125 during the transaction entry process in 425.

If the business is not featuring specific charities, the customer may be able to choose the charity recipient from among any public charity. In 425, the business may allow, the customer to select the charity recipient immediately. In 430, the cashier, for example, may input the customer's choice of charity recipient in the system. In 435, if the customer does not want a receipt of their event participation, the customer may not have to provide any further information. In 445, the business may simply record the amount of the customer's eligible purchase into Causetown 110. In 450, the transaction (e.g. purchases 185) may be submitted (e.g., by clicking a button or automatically) to Causetown 110. In 440, if the customer had wanted a receipt in 435, or the business had not allowed the customer to immediately select the charity recipient in 425, the customer may be required to provide an identifying piece of information that the business may input with the eligible purchase amount (e.g., purchases 185) in 445, so that Causetown 110 may send a charity selection link to the customer in 450. The customer identifying piece of information in 440 may be an email address, a number of an SMS-enabled phone, and/or an ID number assigned by Causetown 110 to that customer if they had previously registered with the system.

In 410, if the business is featuring one or more charities, the customer may choose featured charities immediately in 425. Accordingly, the customer is not required to provide any identifying information in 440 unless the customer wants to receive a receipt in 435. If the business is featuring one or more charities in 410 but does allow the customer to choose a non-featured charity in 415, the customer may choose one of the featured charities in 420 or may choose any other charity.

FIG. 5 depicts an illustrative diagram of transmission paths used to send sales transactions 150 (e.g., sales transaction data) to the system. In FIG. 5, user devices with web browsers 510 are expected to be a transmission medium for transmitting sales transactions 150 to the system. Sales transactions 150 may be transmitted over the Internet 540 to web pages 550. Individuals 115 may view and interact with web pages 550. Submission of data in web page 550 may transmit sales transactions 150 and related information back to the data storage device 580.

An example embodiment may or may not include an API 560 to receive sales transactions 150. Such an API 560 may require POS programmers to write integration code against it.

In addition to user devices 510, various point-of-sale (POS) systems 520 may integrate with the API 560 to send sales transactions 150 to the system, Causetown 110, and/or billing records 145. In some cases, the POS System 520 may enable integration via a webhook 570, where an administrator of an account on the POS system 520 can configure a callback to the webhook 570 specifically designed to transmit a custom specified set of data (specifically, sales transactions 150 and/or associated sales data) to the webhook 570 endpoint.

Finally, in a more general sense, payment networks 530 may integrate with the API 560 or enable a callback to the webhook 570 for the purpose of sending a custom specified set of data (specifically, sales transactions 150 and/or associated sales data).

FIG. 6 depicts an example screen shot of a web form for receiving transaction data (e.g., sales transactions 150) from any Internet-enabled device. During and/or after a promotion, businesses 120 may transmit transaction data to the system (e.g., Causetown 110, and/or billing records 145, etc.) through a website form (e.g., FIG. 12). For each customer, businesses 120 may enter into a web form an eligible customer purchase amount 610 and a charity selection option for the customer 620. The businesses 120 may recommend a recipient organization 630 or may allow the customer to designate any other charity the customer chooses 640. The customer may provide an email address, phone number, or other address to which an electronic message may be delivered 650. The system may deliver a website link to the address provided by the customer so that the email recipient may designate a charity sometime after the purchase occurs. In lieu of entering each customer transaction separately, businesses 120 may enter one transaction reflecting total sales for all customers during the period and choose one organization to receive all donations for the period. Businesses 120 may click to review all transaction history 660 (e.g., sales history) and may also associate transactions with specific promotions by selecting the promotion from a list of events 670 prior to entering transactions.

FIG. 7 depicts an example screenshot of a business entering a custom message to appear in transaction summary notification sent to customers after a transaction has been recorded in an embodiment of the invention. In FIG. 7 a business 120 may have accessed profile information to add a custom message 710 to be included with notifications sent to registered individuals 1250 after sales transactions 150 have been captured.

FIG. 8 depicts an example screenshot of an acknowledgment message received by a customer confirming the availability of funds for charitable donations and a custom message from the business in an embodiment of the invention. In FIG. 8 an acknowledgement of a transaction at a charitable promotion event may be displayed including a confirmation of the availability of funds 830, in this example of $2.70, with a custom message 820 that the business 120 provided via editing their profile illustrated in FIG. 7.

FIG. 8 may include a link 810 to allow a user (e.g., customer) to immediately select a recipient organization of the available funds from the transaction without requiring the user to login in an embodiment of the invention. Clicking the link may take the user to a website to select the organization to be the recipient of the available funds for donation from the promotional event.

FIG. 9 depicts an illustrative network diagram of example communication paths used to send information to businesses 120, individuals 115, and/or organizations 125, for example. In FIG. 9, web server 910 may include one or more hardware processors and software processes for disseminating communications that may be triggered by user interaction on the website, or by automated procedures.

One pathway from the web server 910, where messages may be formed, to the audience is via the Internet 940.

An example embodiment may utilize an email server 930 that may be, for example, positioned differently than in the illustrative diagram with respect to the Internet 940.

Individuals 115 may make purchases 185 at businesses 120 and may give their email address as part of sales transactions 150. Accordingly, a transaction receipt may be sent to the supplied email address via the Email server 930. If the Individual 115 gives their phone number as part of a Sales Transaction 150, the transaction receipt may be sent to the phone number supplied via the SMS service 950, for example. The SMS service 950 may transmit a text message to the Individual's 115 phone.

When Businesses 120 publish promotional event information 135, information about those events may be transmitted to, for example, Event Aggregators and other Promotional Event distribution channels 180 via Event Sites 960 (for example, EVENTBRITE).

An example embodiment may utilize a Billing Service 970 that may be positioned differently than in the illustrative diagram with respect to the Internet 940 or the Email Server 930.

Some time after businesses 120 enter sales transactions 150, an invoice 155 may be pushed to the billing service 970. Billing service 970 may notify businesses 120 via email about a pending payment.

When businesses 120 pay invoices 155 in full, within one day, the Web Server 910 may request a status update from the billing service 970, and the associated sales transaction 2430 entity may automatically become an eligible sales transaction 2580, which may enter the Disbursement System 2520.

FIG. 10 depicts an example screenshot depicting choosing an organization to be the recipient of the donation generated from a transaction at a charitable promotion event without a user being logged into the system in an embodiment of the invention. The link provided in the acknowledgment notification as illustrated in FIG. 8 may contain information to attribute the selection of the charity 1010 to the user should that user eventually login. Optionally, after the user logs in, the information about the transaction and selected organization 1010 may be accessible to that user.

FIG. 11 depicts an illustrative workflow describing fund collection and disbursement by a computer system (e.g., Causetown 110). In 1100, during and/or after a promotion, the system may receive transaction information from businesses 120. The transaction information may include information regarding customers 2440, sales 2430, and charity beneficiaries 2460.

In 1105, transaction information data may used to invoice businesses 120 for amounts due to recipient organizations 175 (e.g., charities) as well as any other relevant fees or amounts. Invoices 155 may be representations sent from the system to businesses 120 that present amounts due to recipient organizations 175 and/or administrative fees. Financial invoices 155 may be distributed and processed by a third-party billing company. Businesses 120 may register a bank account through the system and authorize the system to automatically debit the registered bank account for monies due in 1110. Otherwise, businesses 120 may initiate payments 160 online through, for example, a payment website in 1115. The system may initiate an electronic transfer of funds from the business account in 1120 to a bank account tied to the system in 1125. At 1130, funds may be available for disbursement to recipient organizations 175.

Each sales transaction 2430 data received may include a customer (e.g., individuals 115 who purchased goods or services through businesses 120) email address or phone number that may be used to send the customer a message confirming the donation in 1155. In 1140, if recipient organizations 175 were not selected when the transaction occurred, the message may also provide a link for the customer to choose a recipient organization 175. When the customer clicks the link in 1145, the customer may be presented with a webpage form that allows the customer to search for and select any charity in the country to receive the donation in 1150.

Business 120 may allow customers to name a recipient organization 175 at the time when purchases 185 are made. The sales transaction data may also include the name of an organization designated to receive a portion of the purchase amount in 1135. Once payment has been received from businesses 120 for all transactions received in 1160, the funds may be recorded as ready to disburse to recipient organizations 175. The system may wait for businesses 120 to pay invoices 155 in 1165 before disbursing funds to recipient organizations 175. Funds across all businesses 120 that are designated for the same recipient organization 175 may be combined in 1175 so that each organization receives one disbursement, even if the disbursement reflects contributions from hundreds of different businesses. If businesses 120 have paid invoices and customers have not yet chosen recipient charities (e.g., selected charities 170), funds may be added to a customer account (e.g., giving bank) that accrues donation amounts 1185 so that the customer may designate one or more recipient charities to receive the funds at a later point in time 1190.

FIG. 12 depicts an illustrative workflow describing an example progression of sales data collection and processing of sales information from a charitable promotion event. In this example, individuals 115 may make qualifying purchases 185 at participating businesses 120 during a charitable promotion event. Qualified purchases 185 may be at the discretion of the participating businesses 120, and often may be described in a description of the promotional event information 135.

Sales transactions 150 may be received from businesses 120. Sales customer information 1280 and sales financial information 1260 may be derived from sales transactions 150. Sales customer information 1280 may include, but is not limited to, email or telephone number. Sales financial information 1260 may include, but is not limited to, purchase price, date and sales customer information 1280, as well as which business 120 recorded this transaction. The participating businesses 120 may have discretion to determine an appropriate method to capture sales transaction information 150 (e.g., entry directly via computer at the time of sale).

Sales customer information 1280 may be used to add the individuals 115 to the database of registered individuals 1250, if not already present in the database. Sales customer information 1280 may be used to activate the notification to choose donation recipient 1270 if the promotion allows for customer choice of donation recipient. In this example, if customer choice is circumvented based on configurations of the promotional event information 135 (e.g., the promotion is for a specific charity or charities), then the notification to choose donation recipient 1270 may not notify the registered individual 1250 but may make the donation designation 1240 based off of one or more decisions of participating businesses 120. Otherwise registered individuals 1250 may have the discretion of donation designations 1240 attributed to the sales transaction information 150.

Sales financial information 1260 may be used by Billing Records 145 (e.g., a database) for a variety of processes including, but not limited to, correlating Sales Financial Information 1260 with Donation Designations 1240 to derive Charitable Contributions Data 1230. The Charitable Contributions Data 1230 may be used, in this example, to generate Donations 165 that are sent to Organizations able to Receive Donations 175 as well as to populate the Charitable Giving Report Engine 1220.

The Charitable Giving Report Engine 1220 may be capable of, but not limited to, generating charitable giving reports that are, in this example, requested by Registered Organizations 1210, Businesses 120, and Registered Individuals 1250. The Charitable Giving Report Engine 1220 may be capable of, but not limited to, creating reports tailored to the requesting entity. For example, registered organizations 1210 could generate a report of total donations designated to their organization by which participating businesses 120.

FIG. 13 illustrates an example of a business report showing weekly, monthly, and recipient breakdowns in an embodiment of the invention. FIG. 13 is an example of business reports the charitable giving reports engine 1220 may be capable of. This example shows breakdown of donations generated by month 1310, by week 1300, and by recipient 1320 (e.g., recipient organizations 175). The reporting capabilities of the charitable giving report engine may help participating businesses 120 assess the effectiveness of charitable promotion events based on percentage of sales.

FIG. 14 depicts an example screenshot of a customer transaction history report in an embodiment of the invention. In FIG. 14 row 1430 of this report may contain transaction history including, but not limited to a donation amount (e.g., $1.19) and a featured cause (e.g., A Butterfly's Touch). In this example, the under the column header Featured Cause are the organizations that have been designated to receive donations 165 (e.g., the values under the Donation Amount header).

A transaction history record may have a link 1420 in the location where a selected organization name might appear if a selected organization has not been previously selected. Clicking the link 1420 may provide the user a screen to select the organization to be the recipient of the donation amount generated by the transaction amount from this charitable promotion event 135.

FIG. 15 depicts an example of sources of organizations able to be registered in the system and organizations able to receive donations from charitable promotion events. In FIG. 15, Public Charities Database 130 may be a direct source of organizations able to receive donations 175. There is no requirement that an organization recognized as a public charity to receive a donation generated from a charitable promotion event. In other words, selected charities 170 and recipient organizations may include charities or other organizations that are not recognized (or unknown) as a public charity.

Public Charity Database 130 may also be a starting point source for those organizations to be registered in the system 1510.

Fiscally sponsored organizations 1520 may register provided the EIN (Tax Identification Number) of the IRS 501(c)(3) organization that is their fiscal sponsor is included during the registration processes.

Other types of organizations and entities may be capable of being registered in the system. For example, programs of organizations, school groups, affiliate groups, etc that indicate a 501(c)(3) to receive donations 1530 may be registered in the system. The combination of all registered organizations 1210 and all Public Charity Database 130 are included in the data source of selecting Organizations able to Receive Donations 175.

FIG. 16 contains an example screenshot of the administrative interface used for creating the framework of a campaign in an embodiment of the invention. The goal of a campaign may be to rally multiple businesses 120 to give a percentage of sales 165 to charity (e.g., recipient organizations 175), to rally multiple nonprofits (e.g., organizations 125) to promote those participating businesses 120 to their supporters (e.g., individuals 115), and to rally local community members to patronize those businesses 120 during the times they are giving a percentage of sales to charity. The campaign may be centered on an existing national initiative, local or national partner, or theme.

The administrative interface may allow for the data entry of the components of a campaign. Components of a campaign may include, for example, the campaign tag name 1605, the campaign tag snippet 1610, the campaign heading/subheading/description 1615, the campaign image 1620, and the campaign reference links 1625. All of these elements may be input by an administrator prior to launching the campaign, which is the time at which businesses 120 may join the campaign.

FIG. 17 contains an example screenshot of a campaign page that has been launched by virtue of an administrator adding the campaign structure through the administrative interface (FIG. 16). The page may automatically show the heading and subheading 1700, and description 1705 (input by the administrator 1615), which may serve to describe the campaign for audiences. The page may automatically show the campaign image 1710 (input by the administrator 1620), which may serve to brand the campaign and may optionally allow a viewer to click and learn more about the campaign from a relevant sponsor or partner. If one or more event templates (FIG. 18) are linked to the campaign by the administrator, links to those templates 1715 may also be shown on the page. If businesses 120 have joined the campaign by virtue of creating an event through an event template that was linked to the campaign, the location of businesses 120 may appear on the map 1720 and the campaign's promotional event 135 (including details about businesses 120) may 1 appear in the campaign's event list 1725.

FIG. 18 contains an example screenshot of an event template page in an embodiment of the invention. An event template may contain an event creation form 1805 that may have been filled out in advance for businesses 120 (e.g., using parameters set up by an administrator and recommended to the business). Business 120 may edit the contents of the event creation form before publishing the event. The event template may make event creation easier for businesses 120 by suggesting event parameters and reducing the amount of thought required to create promotional event information 135 for an event. Events created through an event template that may be linked to a campaign by an administrator (by applying the campaign tag name 1605 to the event template) may be automatically added to the campaign page (FIG. 17) the moment promotional event information 135 is created.

FIG. 19 depicts an illustrative workflow of the source and delivery of computer generated promotional materials based on charitable promotion event information. In FIG. 19 Promotional event information 135 may be the source of computer generated promotional material. Businesses 120 may generate business-centric promotional materials 1910 and registered organizations 1210 may generate organizations-center promotional materials 1920. Examples of computer generated promotional material may be presented in, for example, FIG. 20 and FIG. 21

FIG. 20 depicts an example screenshot of computer generated promotional material individuals may use to indicate the charity they would like to receive the donation in an embodiment of the invention. In FIG. 20 a registered organization 1210, in this example, A Butterfly's Touch, has accessed promotional event information 135 for a promotion that business 120, in this example, Joe's Coffee Shop, is hosting to generate, what will be referred to as, Charity Selection Cards that can be distributed to individuals 115. In this example, the Charity Selection Cards may be generated by the computer with all relevant information about the charitable promotional event, including in this example, the name 2010 for businesses 120, location 2020, and percentage to be donated 2030, date and times of the promotion 2040, the registered organization's 1210 name 2050 and EIN 2060 and instruction 2070 to the Individual 115 on how to participate in the promotion so that A Butterfly's Touch benefits from the charitable promotion.

FIG. 21 depicts an example screenshot example of computer-generated flier for a charitable promotion event in an embodiment of the invention. In FIG. 21 a business 120 has accessed promotional event information 135 for a promotion that it is hosting. In this example, Sprig Restaurant has generated a flier for a charitable promotion event it is hosting. The computer generated artwork is usable in a variety of promotional materials, including but not limited to, online promotion and printed material. In this example, specifics 2110 from the promotional event information 135 as well as specifics 2120 about the business 120 are included on the promotional material generated by the computer.

FIG. 22 depicts an example screenshot confirmation page after successfully creating charitable promotion event in an embodiment of the invention. In FIG. 22 links and notifications 2210 to online event sites that may also be promoting the charitable promotion event 135 may be displayed automatically as part of the promotional event information 135 creation. Details of the promotional event 135 that may be distributed to other online event sites 2210 including, but not limited to: event title, event description, date, time, percentage of sales donated, and business information.

Businesses 120 may use the social sharing links 2220 to further promote the promotional event 135.

FIG. 23 depicts an example screenshot of a webpage with RSS data provided by a pull of charitable promotional events and filtered to the needs of the webpage requesting the RSS data in an embodiment of the invention. In FIG. 23 the RSS feed 2310 may be displayed on a website that may have been filtered to that local community. Once the filters are in place by the requesting website's webpage, the RSS feed 2310 may automatically be pulled in a structured way to be displayed on that website.

FIG. 24 depicts an illustrative entity model of an event promotion system in an example embodiment. In FIG. 24, a business 2410 entity must exist before any other entity may exist. A business 2410 entity may be associated with zero or more published event 2420 entities.

A published event 2420 entity may be associated with zero or more sales transaction 2430 entities. A sales transaction 2430 entity may be associated with zero or one customer 2440 entity. A sales transaction 2430 entity may be associated with zero or one transaction charity 2460 entity, which may be an association between sales transaction 2430 entity, charity 2450 entity, and customer 2440 entity. A transaction charity 2460 entity may be associated with one sales transaction 2430 entity and one charity 2450 entity, and may be associated with zero or one customer 2430 entity.

If a sales transaction 2430 is associated with zero transaction charity 2460 entities, then that sales transaction 2430 entity must be associated with exactly one customer 2440 entity. Likewise, if a sales transaction 2430 entity is associated with zero customer 2440 entities, then that sales transaction 2430 must be associated with exactly one transaction charity 2440 entity. A transaction charity 2440 entity may be associated with one customer 2440 entity and may be associated with one transaction charity 2460 entity.

An invoice 2435 entity must be associated with exactly one business 2410 entity, and invoice 2435 entity may be associated with zero or more sales transaction 2430 entities, and an invoice 2435 entity may be associated with zero or one billing period 2436 entity.

If an invoice 2435 entity is associated with zero billing period 2436 entities, then that invoice 2435 entity must be associated with one or more sales transaction 2430 entities.

An invoice 2435 entity, that has exactly one association to a billing period 2436 entity, may have zero associations to Sales Transaction 2430 entities when there have been no individuals 115 making promotional event purchases 185 with the business 120 referenced in the associated business 2410 entity for the duration defined in the associated billing period 2436 entity.

When an organization 125 proposes a promotional event 140 to one or more businesses 120, that promotional event 140 will be referenced by a proposed event 2490 entity that is associated to exactly one charity 2450 entity. If the one or more businesses 120 accept the proposed promotional event 140, the resulting promotional event 135 will be reference by a published event 2420 entity, which will have an association to the proposed event 2490 entity referenced by the original proposed promotional event 140.

A published event 2420 entity may have zero or one association to event template 2475 entities. An event template 2475 may have zero or more associations to campaign 2480 entities. An association between a published event 2420 entity and a campaign 2480 entity is established through an association with a common event template 2475 entity.

An example embodiment may include a draft event 2470 entity which is associated with one and exactly one business 2410 entity. A draft event 2470 entity may be associated with zero or one published event 2420 entity. A published event 2420 entity may be associated with zero or one draft event 2470 entity. A draft event 2470 entity may be associated with zero or one event template 2475 entity. A published event 2420, that derived from a draft event 2470 entity that was associated with exactly one event template 2470 entity, will have exactly one association to the same event template 2475 entity.

FIG. 25 depicts an illustrative entity model of a donation disbursement system in an example embodiment. In FIG. 25, a loose relationship is denoted between entities in the main database 2510 and the disbursement database 2520. These loose relationships denote the derivation of entities when data is transferred from the main database 2510 to the disbursement database 2520, and are not meant to imply a relationship constraint.

Eligible sales transactions 2580 refer to those sales transactions 2430 entities that are associated to invoices 2435 that have been fully paid (e.g., all funds for associated donations have been received).

When sales transaction 2430 entities become eligible sales transactions 2580, a disbursement queue processor (not illustrated) may moves data from the main database 2510 to the disbursement database 2520.

All eligible sales transaction 2430 entities are copied to transactions 2530 entities. For each customer 2440 entity that is associated to one of these eligible sales transactions 2580, a customer account 2530 entity is established if one does not already exist. All transaction charity 2460 entities that are associated to one of these eligible sales transactions 2580 are copied to designated donation 2560. For each charity 2450 that is associated to one of these designated donations 2560, a disbursement org account 2570 entity may be established if one does not already exist.

A customer account 2530 entity must be associated to one or more transaction 2540 entities.

A transaction 2540 entity may be associated to zero or one customer account 2530 entity. If a transaction 2540 entity is associated to zero customer account 2530 entities, then that transaction 2540 entity must be associated to exactly one designated donation 2560 entity. If a transaction 2540 entity is associated to zero designated donation 2560 entities, then that transaction 2540 must be associated to exactly one customer account 2530 entity.

A customer account 2530 entity may be associated to zero or more allocation plan 2550 entities. Allocation plan 2550 entities are created by a separate process when an individual 115 selects charities 170 in the giving bank 1190.

When a new allocation plan 2550 entity is added, a disbursement org account 2570 entity is established if one does not already exist.

An allocation plan 2550 entity must be associated to exactly one customer account 2530 entity, and must be associated to exactly one disbursement org account 2570 entity.

A periodic allocation processor (not illustrated) may log account transactions against the customer account 2530 entity and the designated donation 2560 entity by applying rules specified in the associated allocation plan 2550 so that the customer account 2530 entity balance is reduced and the designated donation 2560 entity account balance is increased by the amount that has been allocated to the associated disbursement org 2570 entity by the associated allocation plan 2550.

FIG. 26 depicts an illustrative computer system that may be used in implementing an illustrative embodiment of the embodiments described herein. Specifically, FIG. 26 depicts an illustrative embodiment of a computer system 2600 that may be used in computing devices such as, e.g., but not limited to, standalone or client or server devices. FIG. 26 depicts an illustrative embodiment of a computer system that may be used as client device, or a server device, etc. The invention (or any part(s) or function(s) thereof) may be implemented using hardware, software, firmware, or a combination thereof and may be implemented in one or more computer systems or other processing systems. In an illustrative embodiment, the invention may be directed toward one or more computer systems capable of carrying out the functionality described herein. For example, Causetown 110 and connection devices for individuals 115, businesses 120, and organizations 125 may be implemented using one or more embodiments of computer system 2600. Furthermore, components of Causetown 110 such as billing records 145 may be implemented with one or more embodiments of computer system 2600.

An example of a computer system 2600 is shown in FIG. 26, depicting an illustrative embodiment of a block diagram of an illustrative computer system useful for implementing the invention. Specifically, FIG. 26 illustrates an example computer 2600, which in an illustrative embodiment may be, e.g., (but not limited to) a personal computer (PC) system running an operating system such as, e.g., (but not limited to) MICROSOFT® WINDOWS® NT/98/2000/XP/Vista/Windows 7/etc. available from MICROSOFT® Corporation of Redmond, Wash., U.S.A. or an Apple computer executing MAC® OS from Apple® of Cupertino, Calif., U.S.A. However, the invention is not limited to these platforms. Instead, the invention may be implemented on any appropriate computer system running any appropriate operating system. In one illustrative embodiment, the invention may be implemented on a computer system operating as discussed herein. An illustrative computer system, computer 2600 is shown in FIG. 26. Other components of the invention, such as, e.g., (but not limited to) a computing device, a communications device, a telephone, a personal digital assistant (PDA), an iPhone, an iPad, a 3/4G wireless device, a wireless device, a personal computer (PC), a handheld PC, a laptop computer, a smart phone, a mobile device, a netbook, a handheld device, a portable device, an interactive television device (iTV), a digital video recorder (DVR), client workstations, thin clients, thick clients, fat clients, proxy servers, network communication servers, remote access devices, client computers, server computers, peer-to-peer devices, routers, web servers, data, media, audio, video, telephony or streaming technology servers, etc., may also be implemented using a computer such as that shown in FIG. 26. Computer system 2600 may be connected to a network and/or interact with a networked cloud of computers.

The computer system 2600 may include one or more processors, such as, e.g., but not limited to, processor(s) 2604. The processor(s) 2604 may be connected to a communication infrastructure 2606 (e.g., but not limited to, a communications bus, cross-over bar, interconnect, or network, etc.). Processor 2604 may include any type of processor, microprocessor and/or processing logic that may interpret and execute instructions (e.g., for example, a field programmable gate array (FPGA)). Processor 2604 may comprise a single device (e.g., for example, a single core) and/or a group of devices (e.g., multi-core). The processor 2604 may include logic configured to execute computer-executable instructions configured to implement one or more embodiments. The instructions may reside in main memory 2608 or secondary memory 2610. Processors 2604 may also include multiple independent cores, such as a dual-core processor or a multi-core processor. Processors 2604 may also include one or more graphics processing units (GPU) which may be in the form of a dedicated graphics card, an integrated graphics solution, and/or a hybrid graphics solution. Various illustrative software embodiments may be described in terms of this illustrative computer system. After reading this description, it will become apparent to a person skilled in the relevant art(s) how to implement the invention using other computer systems and/or architectures.

Computer system 2600 may include a display interface 2602 that may forward, e.g., but not limited to, graphics, text, and other data, etc., from the communication infrastructure 2606 (or from a frame buffer, etc., not shown) for display on the display unit 2630. The display until 2630 may be, for example, a television, a computer monitor, or a mobile phone screen. The output may also be provided as sound through a speaker.

The computer system 2600 may also include, e.g., but is not limited to, a main memory 2608, random access memory (RAM), and a secondary memory 2610, etc. Main memory 2608, random access memory (RAM), and a secondary memory 2610, etc., may be a computer-readable medium that may be configured to store instructions configured to implement one or more embodiments and may comprise a random-access memory (RAM) that may include RAM devices, such as Dynamic RAM (DRAM) devices, flash memory devices, Static RAM (SRAM) devices, etc.

The secondary memory 2610 may include, for example, (but is not limited to) a hard disk drive 2612 and/or a removable storage drive 2614, representing a floppy diskette drive, a magnetic tape drive, an optical disk drive, a compact disk drive CD-ROM, flash memory, etc. The removable storage drive 2614 may, e.g., but is not limited to, read from and/or write to a removable storage unit 2618 in a well-known manner. Removable storage unit 2618, also called a program storage device or a computer program product, may represent, e.g., but is not limited to, a floppy disk, magnetic tape, optical disk, compact disk, etc. which may be read from and written to removable storage drive 2614. As will be appreciated, the removable storage unit 2618 may include a computer usable storage medium having stored therein computer software and/or data.

In alternative illustrative embodiments, secondary memory 2610 may include other similar devices for allowing computer programs or other instructions to be loaded into computer system 2600. Such devices may include, for example, a removable storage unit 2622 and an interface 2620. Examples of such may include a program cartridge and cartridge interface (such as, e.g., but not limited to, those found in video game devices), a removable memory chip (such as, e.g., but not limited to, an erasable programmable read only memory (EPROM), or programmable read only memory (PROM) and associated socket, and other removable storage units 2622 and interfaces 2620, which may allow software and data to be transferred from the removable storage unit 2622 to computer system 2600.

As an example, the main memory 2608 and/or the secondary memory 2610 may store instructions and/or data for implementing Causetown 110, proposed promotional events 140, promotional event information 135, payments 160, invoices 155, sales transactions 150, customer selected charities 170, organizations 125, donations 165, recipient organizations 175, IRS 501(c)(3) organizations 130, businesses 125, individuals 115, and/or billing records 145.

Computer 2600 may also include an input device 2613 may include any mechanism or combination of mechanisms that may permit information to be input into computer system 2600 from, e.g., a user. Input device 2613 may include logic configured to receive information for computer system 2600 from, e.g. a user. Examples of input device 2613 may include, e.g., but not limited to, a mouse, pen-based pointing device, or other pointing device such as a digitizer, a touch sensitive display device, and/or a keyboard or other data entry device (none of which are labeled). Other input devices 2613 may include, e.g., but not limited to, a biometric input device, a video source, an audio source, a microphone, a web cam, a video camera, and/or other camera. Input device 2613 may communicate with processor 2604 either wired or wirelessly.

Computer 2600 may also include output devices 2615 which may include any mechanism or combination of mechanisms that may output information from computer system 2600. Output device 2615 may include logic configured to output information from computer system 2600. Embodiments of output device 2615 may include, e.g., but not limited to, display 2630, and display interface 2602, including displays, printers, speakers, cathode ray tubes (CRTs), plasma displays, light-emitting diode (LED) displays, liquid crystal displays (LCDs), printers, vacuum florescent displays (VFDs), surface-conduction electron-emitter displays (SEDs), field emission displays (FEDs), etc. Computer 2600 may include input/output (I/O) devices such as, e.g., (but not limited to) communications interface 2624, cable 2628 and communications path 2626, etc. These devices may include, e.g., but are not limited to, a network interface card, and/or modems. Output device 2615 may communicate with processor 2604 either wired or wirelessly.

Communications interface 2624 may allow software and data to be transferred between computer system 2600 and external devices. For example, communications interface 2624 may allow participating businesses 120 to send and receive data to and from Causetown 110 and to and from other processors and processes such as billing records 145.

In this document, the terms “computer program medium” and “computer readable medium” may be used to generally refer to media such as, e.g., but not limited to, removable storage drive 2614, a hard disk installed in hard disk drive 2612, flash memories, removable discs, non-removable discs, etc. In addition, it should be noted that various electromagnetic radiation, such as wireless communication, electrical communication carried over an electrically conductive wire (e.g., but not limited to twisted pair, CATS, etc.) or an optical medium (e.g., but not limited to, optical fiber) and the like may be encoded to carry computer-executable instructions and/or computer data that embodiments of the invention on e.g., a communication network. These computer program products may provide software to computer system 2600. It should be noted that a computer-readable medium that comprises computer-executable instructions for execution in one or more processors may be configured to store various embodiments of the invention.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic.

Further, repeated use of the phrase “in one embodiment,” or “in an illustrative embodiment,” do not necessarily refer to the same embodiment, although they may.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory. A “computing platform” may comprise one or more processors.

Embodiments of the invention may include apparatuses for performing the operations herein. An apparatus may be specially constructed for the desired purposes, or it may comprise a general purpose device selectively activated or reconfigured by a program stored in the device.

Embodiments may be embodied in many different ways as a software component. For example, it may be a stand-alone software package, or it may be a software package incorporated as a “tool” in a larger software product. It may be downloadable from a network, for example, a website, as a stand-alone product or as an add-in package for installation in an existing software application. It may also be available as a client-server software application, or as a web-enabled software application.

According to another embodiment, embodiments may be represented by any of a number of well-known network architecture designs including, but not limited to, peer-to-peer, client-server, hybrid-client (e.g., thin-client), or standalone.

While various embodiments of the invention have been described above, it should be understood that they have been presented by way of example only, and not limitation.

What is claimed is:

1. A computer-implemented method for creating and managing a charitable promotion comprising:
receiving, by a computer, charitable promotion event information associated with a charitable promotion event, wherein the charitable promotion event information is received from one or more businesses and includes at least one of: an event title, one or more event dates, an event description, or a percentage of sales to contribute to one or more customer selected charities;
receiving, by the computer, names and addresses of the one or more businesses involved in the charitable promotion event;
generating, by the computer, promotion materials based on the charitable promotion event information and the names and addresses of the one or more businesses;
distributing, by the computer, the promotion materials based on the charitable promotion event information;
receiving, by the computer, details of purchases made in response to the charitable promotion, wherein the details of purchases made are received from the one or more businesses and include contact information for customers and a purchase amount;
distributing, by the computer, an invoice to the one or more businesses showing amounts due related to the charitable promotion event;
receiving, by the computer, one or more selections of one or more customer selected charities, wherein the one or more selections are performed by one or more customers of the one or more businesses involved in the charitable promotion, the one or more selections are performed by the one or more customers of the one or more businesses at the point of sale or after the charitable promotion event;
receiving, by the computer, amounts due from the one or more businesses, wherein the amounts due include donations related to purchases received by the one or more businesses involved in the charitable promotion event; and
distributing, by the computer, donations due to the one or more customer selected charities.

2. The method of claim 1, further comprising:
creating a campaign for the charitable promotion event, wherein the campaign features a plurality of businesses giving a percentage of sales to charity as part of the campaign.

3. The method of claim 2, further comprising:
creating a promotional webpage containing the charitable promotion event information and maps associated with charitable promotion event;
receiving a request to join the campaign by one or more second businesses;
updating the promotional webpage in real-time with information from the one or more second businesses; and
distributing the promotional webpage through social media or formatting information contained in the promotional webpage for printing.

4. The method of claim 1, further comprising:
providing one or more promotion templates to the one or more businesses for promoting the charitable promotion event, wherein the promotion templates include at least one of: a title, date, description, recommended charitable percentage, recommended decorations, recommended entertainment, recommended taglines, or recommended promotional ideas.

5. The method of claim 1, wherein distributing promotion materials includes at least one of:
posting the charitable promotion event information to online event sites, providing an application programming interface, or widget.

6. The method of claim 1, further comprising:
transmitting pre-designed promotional material based on the charitable promotion event information.

7. The method of claim 1, wherein the one or more customers purchased products or services from the one or more businesses involved in the charitable promotion event.

8. The method of claim 1, wherein the one or more customer selected charities are selected at the point of sale through at least one of: equipment integrated with a point of sale, an internet enabled device, a smart phone, a tablet, a web portal, or a computer.

9. The method of claim 1, further comprising:
receiving a selection by the one or more customers of the one or more businesses at the point of sale of the one or more customer selected charities receiving a charitable contribution arising from the sale from at least one of: equipment integrated with point of sale, an internet enabled device, a smart phone, a tablet, a web portal, or a computer.

10. The method of claim 1, wherein one or more amounts of one or more purchases of the one or more customers of the one or more businesses during the charitable promotion event is entered at the point of sale through at least one of: equipment integrated with point of sale, an internet enabled device, a smart phone, a tablet, a web portal, or a computer.

11. The method of claim 1, wherein one or more amounts of one or more purchases of the one or more customers of the one or more businesses during the charitable promotion event is received from at least one of: equipment integrated with point of sale, an internet enabled device, a smart phone, a tablet, a web portal, or a computer.

12. The method of claim 1, wherein a percentage of one or more purchases of the one or more customers of the one or more businesses to be contributed to a charitable organization is entered at the point of sale through at least one of: equipment integrated with point of sale, an internet enabled device, a smart phone, a tablet, a web portal, or a computer.

13. The method of claim 1, wherein a percentage of one or more purchase of the one or more customers of the one or more businesses to be contributed to a charitable organization is received from at least one of: equipment integrated with point of sale, an internet enabled device, a smart phone, a tablet, a web portal, or a computer.

14. The method of claim 1, wherein the one or more customer selected charities includes any organization classified as a public charity.

15. The method of claim 1, further comprising:
receiving charity organizational information for charities that are not registered as a public charity, including at least one of: a school, a fiscally-sponsored group, or a nonprofit.

16. The method of claim 1, further comprising:
receiving a proposal from a nonprofit, wherein the proposal describes a charitable sales event for participation by one or more businesses and one or more event dates;
transmitting the proposal to the one or more businesses; and
receiving acceptance of the proposal from the one or more businesses.

17. The method of claim 1, further comprising:
receiving sales data and customer data from the one or more businesses, wherein the customer data includes at least one of: an email address or a telephone number; and
transmitting a report on charitable contributions made by the one or more businesses based on the received sales data and customer data.

18. The method of claim 1, further comprising:
receiving one or more custom messages from the one or more businesses to send to the one or more customers; and
transmitting one or more acknowledgments from the one or more businesses to one or more customers confirming availability of the percentage of sales to contribute to the one or more customer selected charities along with the one or more custom messages;

19. The method of claim 18, wherein the one or more acknowledgments are sent by at least one of: email or text message.

20. The method of claim 18, wherein the one or more acknowledgements contain one or more links to one or more websites enabling selection of the one or more customer selected charities, wherein the one or more websites do not require login information.

21. The method of claim 1, further comprising:
calculating one or more amounts for charitable contribution based on the percentage of sales to contribute to the one or more customer selected charities;
generating a monetary account per customer containing the one or more amounts for charitable contribution;
receiving one or more selections of the monetary account and one or more amounts to contribute to the one or more customer selected charities;
transferring the one or more amounts to contribute to the one or more customer selected charities; and
deducting the one or more amounts to contribute from the monetary account.

22. The method of claim 1, further comprising:
transmitting one or more customer history reports, wherein the one or more customer history reports include at least one of: the one or more customer selected charities and the one or more amounts to contribute to the one or more customer selected charities.

23. The method of claim 1, further comprising:
receiving one or more requests from one or more charities; and
transmitting a report on the one or more selections of the one or more customer selected charities and on one or more business donations, wherein the report is transmitted based on the one or more requests from the one or more charities.

24. The method of claim 1, further comprising:
receiving one or more requests from the one or more businesses; and
transmitting a report on generated sales, the one or more customer selected charities, and effectiveness of promotion based on percentage of sales, wherein the report is transmitted based on the one or more requests from the one or more businesses.

25. The method of claim 1, further comprising:
receiving one or more requests from the one or more customers; and
transmitting a report on shopping and dining transactions that generated charitable donations, wherein the report is transmitted based on the one or more requests.

26. The method of claim 1, further comprising:
promoting the charitable promotion event through electronic media; and
providing one or more data feeds for transmittal of the promotion materials, wherein the one or more data feeds include at least one of: an application programming interface, a comma separated values feed, a web feed, or a rich site summary feed.

27. A system for creating and managing a charitable promotion comprising:
an input device configured to receive charitable promotion event information associated with a charitable promotion event and includes at least one of: an event title, one or more event dates, an event description, a percentage of sales to contribute to one or more customer selected charities, names and addresses of one or more businesses involved in the charitable promotion event, or one or more selections of one or more customer selected charities, the one or more selections performed by the one or more customers of the one or more businesses at the point of sale or after the charitable promotion event;
a storage device configured to store the charitable promotion event information; and
at least one processor configured to:
generate promotion materials based on the charitable promotion event information and the names and addresses of one or more businesses, and
distribute the promotion materials based on the charitable promotion event information,
calculate one or more contribution amounts for one or more customers based on the percentage of sales to contribute to one or more customer selected charities and one or more customer sales associated with the charitable promotion event,
associate the one or more contribution amounts with the one or more selections of the one or more customer selected charities; and
distribute an invoice to the one or more businesses showing amounts due related to the charitable promotion event.

28. One or more tangible non-transitory computer-readable storage media for storing computer-executable instructions executable by a computer system having at least one processor, the media storing one or more instructions for:
receiving charitable promotion event information associated with a charitable promotion event, wherein the charitable promotion event is received from one or more businesses and includes at least one of: an event title, one or more event dates, an event description, or a percentage of sales to contribute to one or more customer selected charities;
receiving names and addresses of one or more businesses involved in the charitable promotion event;
generating promotion materials based on the charitable promotion event information and the names and addresses of one or more businesses;
distributing the promotion materials based on the charitable promotion event information;
receiving details of purchases made in response to the charitable promotion, herein the details of purchases made are received from the one or more businesses and include contact information for customers and a purchase amount;
distributing an invoice to the one or more businesses showing amounts due related to the charitable promotion event;
receiving one or more selections of one or more customer selected charities, wherein the one or more selections are performed by one or more customers of the one or more businesses involved in the charitable promotion, the one or more selections are performed by the one or more customers of the one or more businesses at the point of sale or after the charitable promotion event;
receiving amounts due from the one or more businesses, wherein the amounts due include donations related to purchases received by the one or more businesses involved in the charitable promotion event; and
distributing donations to the one or more customer selected charities.
